(19) United States
(12) Patent Application Publication
(10) Pub. No.: US 2011/0293966 A1
(43) Pub. Date: Dec. 1, 2011

(54) MAGNETIC RECORDING MEDIUM AND MAGNETIC RECORDING/REPRODUCING APPARATUS

(75) Inventors: Atsushi HASHIMOTO, Ichihara-shi (JP); Takayuki Fukushima, Ichihara-shi (JP); Gohei Kurokawa, Ichihara-shi (JP)

(73) Assignee: SHOWA DENKO K.K., Tokyo (JP)

(21) Appl. No.: 13/115,744

(22) Filed: May 25, 2011

(30) Foreign Application Priority Data
May 26, 2010 (JP) 2010-120812

(51) Int. Cl. G11B 5/64

(52) U.S. Cl. 428/826

(57) ABSTRACT

A magnetic recording medium which has been made by forming at least one magnetic layer having a granular structure on a substrate by sputtering, wherein said at least one magnetic recording layer having a granular structure comprises magnetic grains separated from each other by an oxide, and is made by sputtering a target comprising cobalt oxide and substantially free from metallic chromium and a chromium alloy. The magnetic grains in the granular structure have an average grain diameter of not larger than 6 nm, and are separated from each other by the oxide with a grain boundary width of at least 1.5 nm. The magnetic grains are minute and separated from each other with an enhanced grain boundary width, and the magnetic recording medium exhibits an enhanced recording density and improved electromagnetic conversion characteristics.

### TECHNICAL FIELD

This invention relates to a magnetic recording medium, and a magnetic recording/reproducing apparatus.

### BACKGROUND ART

A hard disk drive (HDD), one of magnetic recording/reproducing apparatuses, is showing astonishing progress in the recording density. Recently the rate of increase in the recording density is about 50% or more per year. There is still increasing a demand for further enhancing the recording density of magnetic recording/reproducing apparatuses including HDD, and therefore, magnetic recording mediums adapted for enhancement of the recording density are being developed.

Commercially available magnetic recording/reproducing apparatuses are equipped with a magnetic recording medium having a magnetic recording layer with the axis of easy magnetization which is orientated predominantly in the perpendicular direction, namely, a perpendicular magnetic recording medium. Even when recording is conducted at a high recording density in the perpendicular magnetic recording medium, an influence exerted in a boundary region between recording bits by demagnetizing field is minor and clear bit boundaries are assured, therefore, an increase in noise can be suppressed. Further, a decrease in volume of recording bits can be minimized in the perpendicular magnetic recording medium, therefore, the medium is satisfactory in heat fluctuation characteristics.

To improve the recording/reproducing characteristics of a perpendicular magnetic recording medium, a magnetic recording medium having a multi-layer structure comprising an orientation control layer, and two or more magnetic layers has been proposed wherein the magnetic layers are comprised of columnar magnetic crystal grains continuously extending through the magnetic layers, and thus, the magnetic layers exhibit an enhanced perpendicular orientation (see JP 2004-310910 A).

The magnetic layer of the perpendicular magnetic recording medium generally has a granular structure. In the magnetic layer having a granular structure, magnetic grains are covered with a non-magnetic material, and a magnetic mutual action among the magnetic grains are reduced by the non-magnetic material and the magnetic grains are magnetically separated, and therefore, the medium noise can be suppressed.

The non-magnetic material in the magnetic layer having a granular structure is generally comprised of an oxide. As the oxide, it is preferable that an oxide formed among the magnetic grains is in a stable state and can be surely segregated among the magnetic grains as it is. In this regard, oxides of Ti, Si, Cr, Ta, W and Nb are preferably used. As a process forming a preferable granular structure, there has been proposed a process for forming a granular structure by sputtering a target comprising a Co alloy, a first oxide-forming material comprised of Ti oxide and Si oxide, and a second oxide-forming material comprised of Co oxide (see JP 2009-238357 A).

### SUMMARY OF THE INVENTION

### Problems to be Solved by the Invention

As described above, a magnetic mutual action among magnetic grains can be weakened to reduce a medium noise by providing a magnetic layer having a granular structure in a perpendicular magnetic recording medium. However, there is still increasing a demand for further enhancing the recording density of magnetic recording mediums, and therefore, it is eagerly desired that the magnetic layer has a granular structure such that magnetic grains are rendered finer and grain boundary widths, i.e., widths of a non-magnetic material covering magnetic grains are more widened.

In view of the foregoing, a primary object of the present invention is to provide a magnetic recording medium having a magnetic layer with a granular structure such that magnetic grains are rendered finer and grain boundary widths of magnetic grains are more widened, and therefore, a higher recording density can be effected in the magnetic recording medium, and the magnetic recording medium exhibits more improved electromagnetic conversion characteristics.

### Means for Solving the Problems

To achieve the above-mentioned object, the present inventors made an extensive research on the formation of a magnetic layer having a granular structure, and made the following findings.

That is, the inventors have found that, when a Co magnetic layer having a granular structure is formed by sputtering a target containing CoO, magnetic Co grains formed are rendered more minute and grain boundary widths of magnetic grains are greatly widened, and the grain boundaries become clear and sharp. Thus it has been elucidated that CoO contained in the target is separated into Co and O, and the separated Co exhibits an action of giving fine and discrete magnetic grains, and the separated oxygen widens the grain boundary widths of magnetic grains.

Further, the inventors have found that CoO contained in the target is easily separated into Co and O in a sintering step or another step in the course of preparing the target, and further that, when the target contains metallic Cr or a Cr alloy, the metallic Cr or Cr alloy are easily bonded with oxygen separated from CoO, and thus, lessen the effect of rendering magnetic grains minute and discrete, and widening the grain boundary widths of magnetic grains.

Further, the inventors have found that, when a Co magnetic layer having a granular structure is formed by sputtering a target containing CoO, but substantially free from metallic Cr and a Cr alloy, the separation of CoO is promoted, and magnetic Co grains formed are rendered far more minute and grain boundary widths of magnetic grains are more greatly widened, and the grain boundaries become prominently clear and sharp. It has been further found that the above-mentioned beneficial effects are more enhanced, and a magnetic recording medium exhibiting excellent electromagnetic conversion characteristics can be obtained, when a magnetic recording layer having a granular structure is formed by a co-sputtering step wherein at least two targets having different compositions are concurrently sputtered, or a sequential sputtering step wherein at least two targets having different compositions are sequentially sputtered, wherein one of the targets comprises cobalt oxide and is substantially free from metallic Cr and a Cr alloy, and another of the targets contains chromium.

Based on the above-mentioned findings, the present invention has been completed.

Thus, in accordance with the present invention, there are provided the following magnetic recording mediums.

(1) A magnetic recording medium which has been made by forming at least one magnetic layer having a granular structure on a substrate by sputtering, characterized in that said at least one magnetic recording layer having a granular structure comprises magnetic grains which are separated from each other by an oxide, and said at least one magnetic recording layer having a granular structure is made by sputtering a target which comprises cobalt oxide and is substantially free from metallic chromium and a chromium alloy.

(2) The magnetic recording medium as described above in (1), wherein said at least one magnetic recording layer having a granular structure comprises magnetic grains having an average grain diameter of not larger than 6 nm; and said magnetic grains are separated from each other by the oxide with a grain boundary width of at least 1.5 nm.

(3) The magnetic recording medium as described above in (1), wherein said at least one magnetic recording layer having a granular structure has been formed by a co-sputtering step wherein at least two targets having different compositions are concurrently sputtered, or a sequential sputtering step wherein at least two targets having different compositions are sequentially sputtered; and,

at least one of said at least two targets, used in the co-sputtering step and the sequential sputtering step, includes a first target comprising cobalt oxide and being substantially free from metallic chromium and a chromium alloy, and the other of said at least two targets includes a second target containing chromium.

(4) The magnetic recording medium as described above in (3), wherein the first target comprises a cobalt-platinum alloy which is substantially free from chromium, and further comprises cobalt oxide; and the second target comprises a cobalt- and chromium-containing alloy, and further comprises an oxide other than cobalt oxide.

(5) The magnetic recording medium as described above in (4), wherein the oxide other than cobalt oxide, contained in the second target, is at least one oxide selected from the group consisting of SiO₂, TiO, TiO₂, ZrO₂, Cr₂O₃, Ta₂O₅, Nb₂O₅ and Al₂O₃.

(6) The magnetic recording medium as described above in (4), wherein the first target comprises a cobalt-platinum alloy which is substantially free from chromium, and further comprises cobalt oxide, and an oxide other than cobalt oxide.

(7). The magnetic recording medium as described above in (6), wherein the oxide other than cobalt oxide, contained in the first target, is at least one oxide selected from the group consisting of SiO₂, TiO, TiO₂, ZrO₂, Cr₂O₃, Ta₂O₅, Nb₂O₅ and Al₂O₃.

In accordance with the present invention, there is further provided the following magnetic recording/reproducing apparatus.

(8) A magnetic recording/reproducing apparatus characterized as being provided with a magnetic recording medium as described above in (1), and a magnetic head for recording and reproducing an information in the magnetic recording medium.

### Effects of the Invention

In the magnetic layer of the magnetic recording medium according to the present invention, the magnetic grains are minute, and grain boundary width of the magnetic grains is wide, and the grain boundaries are sharp and clear. Therefore, the magnetic recording medium exhibits improved write characteristics and a reduced noise. A magnetic recording/reproducing apparatus provided with the magnetic recording medium is adaptable for further enhancement of the recording density.

### BRIEF DESCRIPTION OF THE DRAWINGS

FIG. 1 is a cross-section illustrating an example of a magnetic recording medium according to the present invention.

FIG. 2 is an enlarged vertical section of a multi-layer structure comprising orientation-control layers and magnetic layers, wherein columnar crystal grains are grown continuously in a direction perpendicular to the substrate plane.

FIG. 3 is an enlarged vertical section of a multi-layer structure comprising magnetic layers constituting a perpendicular magnetic layer.

FIG. 4 is a schematic illustration of an example of the magnetic recording/reproducing apparatus according the present invention.

FIG. 5 is a TEM photograph of the granular magnetic layer of the magnetic recording medium according to the present invention.

FIG. 6 is a TEM photograph of the granular magnetic layer of a magnetic recording medium according to prior art.

### DETAILED EXPLANATION OF THE INVENTION

The magnetic recording medium of the present invention and the magnetic recording/reproducing apparatus provided therewith will be described in detail with reference to the accompanying drawings. In the drawings, to render it easy to understand the feature of illustrated parts or elements, the scale adopted therefor may not be constant and the parts and elements may be illustrated with a certain extent of exaggeration.

I. Magnetic Recording Medium

The magnetic recording medium of the present invention has a multi-layer structure which generally has a non-magnetic substrate, a soft magnetic underlayer, an orientation control layer for controlling the orientation in a layer formed thereon, and a perpendicular magnetic layer having an axis of easy magnetization extending substantially perpendicularly to the plane of the non-magnetic substrate.

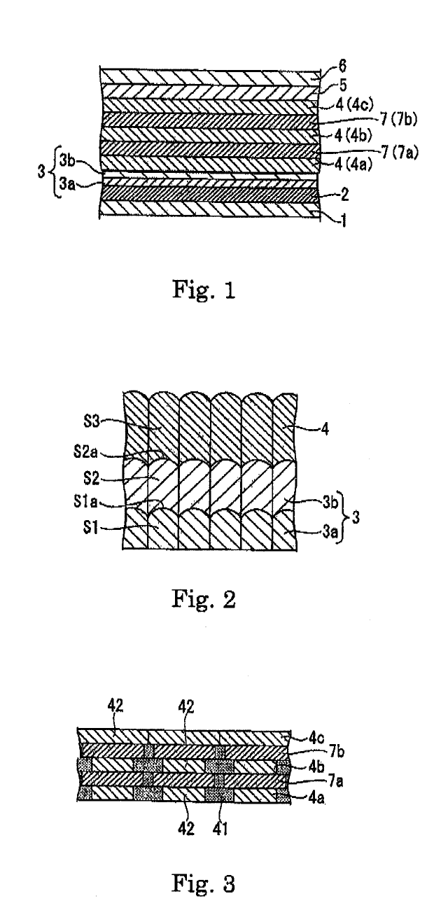

In FIG. 1 illustrating a representative example of the magnetic recording medium of the present invention, the illustrated multi-layer structure is produced by forming, on a non-magnetic substrate 1, a soft magnetic underlayer 2, an orientation control layer 3 comprised of a first orientation control layer 3a and a second orientation control layer 3b, perpendicular magnetic layers 4 and 7 comprised of a first magnetic layer 4a, a second magnetic layer 7a, a third magnetic layer 4b, a fourth magnetic layer 7b and a fifth magnetic layer 4c, a protective overcoat 5, and a lubricating layer 6, in this order. The soft magnetic underlayer 2 and an orientation control layer 3 form together an under layer.

Non-Magnetic Substrate

The non-magnetic substrate 1 can be made of metallic materials such as aluminum and an aluminum alloy; or non-metallic materials such as glass, ceramics, silicon, silicon carbide and carbon. The non-magnetic substrate 1 can be a metal substrate or a non-metal substrate, which has a NiP layer or a NiP alloy layer, formed by, for example, plating or sputtering.

The glass substrate includes, for example, amorphous glass substrates such as substrates of conventional soda lime glass and aluminosilicate glass; and crystallized glass substrates such as lithium-containing crystallized glass substrate. The ceramic substrate includes, for example, substrates made of conventional aluminum oxide, sintered bodies predominantly comprised of aluminum nitride or silicon nitride, and fiber-reinforced products thereof.

The non-magnetic substrate 1 is adaptable for recording at a high recording density utilizing a magnetic head floating at a low height. Therefore, the non-magnetic substrate 1 preferably has an average surface roughness (Ra) of not larger than 2 nm (20 angstrom), more preferably not larger than 1 nm. In view of the adaptability for recording at a high recording density utilizing a magnetic head floating at a low height, the non-magnetic substrate 1 preferably has a tiny surface undulation (Wa) of not larger than 0.3 nm, more preferably not larger than 0.25 nm. Further, in view of the floating stability of a magnetic head, at least one of chamferred face of the end face, and the side face of the non-magnetic substrate 1 preferably has a surface roughness (Ra) of not larger than 10 nm, more preferably not larger than 9.5 nm. The tiny surface undulation (Wa) can be determined by measuring an average surface roughness in a measurement range of 80 μm, using, for example, a P-12 profilometer (available from KLM-Tencor Corporation)

If the non-magnetic substrate 1 is kept in contact with a soft magnetic underlayer 2 predominantly comprised of Co or Fe, it is possible that corrosion builds up due to the gas adsorbed on the surface, moisture, or diffusion of components of the substrate. Therefore, to prevent the corrosion, an adhesion layer is preferably formed between the non-magnetic substrate and the soft magnetic underlayer 2. The adhesion layer can be formed, for example, by sputtering Cr, a Cr alloy, Ti and a Ti alloy. The adhesion layer preferably has a thickness of at least 2 nm.

Soft Magnetic Underlayer

A soft magnetic underlayer 2 is formed on the non-magnetic substrate 1. The soft magnetic underlayer 2 can be formed either directly on the non-magnetic substrate, or with an adhesion layer intervening between the non-magnetic substrate 1 and the soft magnetic underlayer 2. The procedure for formation of the soft magnetic underlayer 2 is not particularly limited, and sputtering can be adopted.

The soft magnetic underlayer 2 has a function of enlarging a component, which is perpendicular to the substrate surface, of magnetic flux produced from a magnetic head; and further fixing the direction of magnetization in the perpendicular magnetic layer 4 on which an information is recorded, more firmly to the direction perpendicular to the substrate surface. This function of the soft magnetic layer 2 is more markedly manifested especially when a single magnetic pole head suitable for perpendicular recordation is used as a magnetic head.

The soft magnetic underlayer 2 can be made of a soft magnetic material containing, for example, Fe, Ni or Co. As specific examples of the soft magnetic material, there can be mentioned CoFe alloys such as CoFeTaZr and CoFeZrNb; FeCo alloys such as FeCo and FeCoV; FeNi alloys such as FeNi, FeNiMo, FeNiCr and FeNiSi; FeAl alloys such as FeAl, FeAlSi, FeAlSiCr, FeAlSiTiRu and FeAlO; FeCr alloys such as FeCr, FeCrTi and FeCrCu; FeTa alloys such as FeTa, FeTaC and FeTaN; FeMg alloys such as FeMgO; FeZr alloys such as FeZrN; FeC alloys; FeN alloys; FeSi alloys; FeP alloys; FeNb alloys; FeHf alloys; and FeB alloys.

The soft magnetic underlayer 2 can also be made of microcrystalline structural materials such as FeAlO, FeMgO, FeTaN or FeZrN, wherein the content of Fe is at least 60 atomic %, or a material having a granular structure such that microcrystalline grains are dispersed in a matrix.

The soft magnetic underlayer 2 can also be made of Co alloys having an amorphous structure which contains at least 80 atomic % of Co, and further contains at least one element selected from Zr, Nb, Ta, Cr and Mo. As preferable examples of the Co alloys, there can be mentioned CoZr, CoZrNb, CoZrTa, CoZrCr and CoZrMo.

The soft magnetic underlayer 2 preferably has a coercivity Hc of not larger than 100 Oe, more preferably not larger than 20 Oe. Note, 10 Oe is equal to 79 A/m. When the soft magnetic underlayer 2 has a coercivity Hc larger than 100 Oe, the soft magnetic characteristics are insufficient and the square reproduction waveform tends to be distorted.

The soft magnetic underlayer 2 preferably has a saturated magnetic flux density Bs of at least 0.6 T, more preferably at least 1 T. When the soft magnetic underlayer 2 has a saturated magnetic flux density Bs of smaller than 0.6 T, the square reproduction waveform tends to be distorted.

The product Bs·t (T·nm) of a saturated magnetic flux density Bs (T) of the soft magnetic underlayer 2 and a thickness t (nm) thereof is preferably at least 15 (T·nm), more preferably at least 25 (T·nm). When the product Bs·t of a soft magnetic underlayer 2 is smaller than 15 (T·nm), the square reproduction waveform tends to be distorted, and the overwrite (OW) characteristics (i.e., recording characteristics) are often deteriorated.

The soft magnetic underlayer 2 is preferably a double layer comprised of two soft magnetic films, and more preferably has a laminate structure comprising two soft magnetic films and a Ru film sandwiched between the two soft magnetic films. Especially when the Ru film has a thickness in the range of from 0.4 to 1.0 nm, or from 1.6 to 2.6 nm, the two soft magnetic films can form an antiferromagnetically coupled (AFC) structure. In the case when the two soft magnetic films form an AFC structure, a spike noise can be suppressed.

In the outermost surface (i.e., the surface located in contact with an orientation control layer) of the soft magnetic underlayer 2, it is preferable that a soft magnetic material forming the soft magnetic underlayer 2 is partially or completely oxidized. When the outermost surface portion of the soft magnetic underlayer 2 is oxidized, magnetic fluctuation on the surface of the soft magnetic underlayer 2 can be suppressed, and thus, noise occurring due to magnetic fluctuation can be minimized, and recording/reproduction characteristics of the magnetic recording medium are improved.

Orientation Control Layer

An orientation control layer 3 is formed on the soft magnetic underlayer 2. The orientation control layer 3 has a function of rendering minute crystal grains in a perpendicular magnetic layer 4, and improve recording/reproducing characteristics of the magnetic recording medium. As shown in FIG. 1, the orientation control layer 3 in the embodiment illustrated therein is comprised of a first orientation control layer 3a formed on the soft magnetic underlayer 2, and a second orientation control layer located in contact with the perpendicular magnetic layer 4.

The first orientation control layer 3a has a function of enhancing density of nuclear generation, and contains crystals which form nuclei of columnar crystals constituting the orientation control layer 3. The first orientation control layer 3a in this embodiment comprises columnar crystals S1 which have been grown from nucleus-forming crystals, as illustrated in FIG. 2. The top of each columnar crystal S1 forms a dope-formed convex face S1a.

The first orientation control layer 3a includes, for example, a Ru or Ru alloy layer having a thickness of several nanometers. The first orientation control layer 3a can be a laminate structure comprising a magnetic layer containing a magnetic material with a thickness of 0.2 nm to 1.0 nm, and a Ru layer containing at least 50 atomic % of Ru with a thickness of 0.2 nm to 1.0 nm. The Ru layer contains Ru in an amount of at least 50 atomic %, preferably at least 80 atomic %. When the content of Ru in the Ru layer is at least 80 atomic %, the hcp structure of the Ru layer is sufficiently steady and not easily destroyed, and the S/R is more improved.

In the case when the sputtering for forming the first orientation layer 3a is conducted at a gas pressure in the range of from 0.5 Pa to 5 Pa, the first orientation control layer 3a comprising crystals forming nuclei of columnar crystals can is easily formed.

When the sputtering gas pressure for the first orientation control layer 3a is smaller than the above-mentioned range, the resulting film exhibits a poor orientation and the effect of rendering minute crystal grins 42 constituting the magnetic layer 4 is liable to be insufficient. In contrast, when the sputtering gas pressure for the first orientation control layer 3a is larger than the above-mentioned range, the resulting film often exhibits a poor crystalline property, and is hard, and tends to give a magnetic recording medium having a low S/N ratio with a reduced reliability.

As illustrated in FIG. 2, the second orientation control layer 3b comprises columnar crystals S2 continuously extending from crystals forming nuclei of columnar crystals S1, wherein each columnar crystal S2 has a dope-form convex face at the top thereof. In this embodiment, the columnar crystals S2 in the second orientation control layer 2b have been grown on the dope-formed faces of columnar crystals S1 grown from crystals forming nuclei in the first orientation control layer 3a. The columnar crystals S2 constituting the second orientation control layer 3b extend continuously in the thickness direction on the columnar crystals S1 constituting the first orientation control layer 3a.

The second orientation control layer 3b preferably has a thickness of at least 7 nm. When the thickness of the second orientation control layer 3b is too small, it is difficult to obtain the effect of enhancing the orientation of perpendicular magnetic layer 4 and rendering minute magnetic grains 42 (FIG. 3) in the perpendicular magnetic layer 4, and further difficult to enhance the S/N ratio to the desired extent.

The second orientation control layer 3b can have a laminate structure having the same as that of the first orientation control layer 3a.

The laminate structure of the second orientation control layer 3b may be made of the same material as or different material from that of the laminate structure of the first orientation control layer 3a. More specifically, one of the first orientation control layer 3a and the second orientation control layer 3b can be a laminate structure comprising a Co layer and a Ru layer, and the other of the two orientation control layers 3a and 3b can be a laminate structure comprising a Fe layer and a Ru layer.

The formation of the second orientation control layer 3b can be effected by the same way including sputtering, but, the sputtering for forming the second orientation control layer 3b is preferably conducted at a pressure higher than that for the first orientation control layer 3a, namely, at a sputtering pressure in the range of from 5 Pa to 18 Pa.

When the formation of the second orientation control layer 3b is carried out at the above-mentioned sputtering pressure, a layer comprised of columnar crystals S2 having a dome-form convex face S2a at the top thereof can be easily formed in a manner such that the columnar crystals S2 are grown continuously in the thickness direction on the crystals forming nuclei of the columnar crystals S1 in the first orientation control layer 3a.

Perpendicular Magnetic Layer

At least one perpendicular magnetic layer in the magnetic recording medium according to the present invention has a granular structure formed by sputtering, which comprises magnetic grains separated from each other by an oxide, wherein the sputtering is carried out using a target which comprises cobalt oxide and is substantially free from metallic chromium and a chromium alloy. By sputtering such target, the magnetic grains can be rendered minute and discrete, and grain boundary widths can be enlarged.

By the phrase “substantially free from metallic chromium and a chromium alloy”, we mean that the target does not contain metallic chromium nor a chromium alloy, or, even if the target contains metallic chromium or a chromium alloy, its content is very minor, usually not larger than approximately 3 atomic %. The chromium alloy is a metallic material, and a chromium oxide is not included in the chromium alloy.

Even if a chromium oxide is contained in the target which comprises cobalt oxide and is substantially free from metallic chromium and a chromium alloy, as used in the present invention, there is not a possibility that the cobalt oxide is decomposed by the chromium oxide.

The sputtering target is made usually by a process wherein metal powders are mixed together at a predetermined ration, the thus-obtained mixture is subjected to a compression molding, and then the obtained molding is sintered at a high temperature in vacuum or an inert gas atmosphere. The metal powders used are generally prepared by a gas atomizing method wherein a raw material is melted in an inert gas atmosphere or in vacuum, and the molten material is atomized by an inert gas such as argon gas or nitrogen gas. At atomization, the molten material is rapidly and directly coagulated from a molten state, and therefore, the resulting coagulated system is very minute and has high homogeneity and uniformity, and is comprised of spherical grains having an average grain diameter of several μm.

The preparation of a solid molding of the metal powders for target includes, for example, conventional sintering methods and hot pressing methods, and a hot isostatic pressing (HIP) method and a hot extrusion method. For targets used for making a magnetic recording medium, high homogeneity and uniformity, and minimized occurrence of particles are required, and therefore, sintering is conducted at a temperature of at least 400° C. in vacuum or an inert gas atmosphere. The present inventors have found that, at a step of high temperature sputtering of a target comprising CoO, the CoO is separated into Co and oxygen, and the separated Co has a function of rendering Co magnetic grains minute, and the oxygen has a function of enlarging the grain boundary width. However, CoO contained in the target is easily separated at the step of high temperature sputtering, and, especially when metallic chromium or a chromium alloy is contained in the target, chromium is easily bonded with the oxygen of CoO to form oxides such as, for example, CoCr₂O₄ and Cr₂O₃. Thus, CoO is difficult to be separated into Co and oxygen at the step of sintering in the co-presence of metallic chromium or a chromium alloy, and the above-mentioned desired effect is suppressed.

In the magnetic recording medium according to the present invention, the magnetic recording layer having a granular structure has been formed preferably by a co-sputtering step wherein at least two targets having different compositions are concurrently sputtered, or a sequential sputtering step wherein at least two targets having different compositions are sequentially sputtered; wherein at least one of the at least two targets, used in the co-sputtering step and the sequential sputtering step, includes a first target comprising cobalt oxide and being substantially free from metallic chromium and a chromium alloy, and the other of said at least two targets includes a second target containing chromium. It is preferable that the second target containing chromium doe not contain CoO. This is because the undesirable fluctuation in composition of target due to the decomposition of CoO can be minimized.

The magnetic layer having a granular structure in a magnetic recording medium is generally made of CoCr alloys, and the composition of CoCr alloys suitable for the magnetic layer is restricted. However, in the present invention, at least two targets having different compositions are used, wherein at least one (first target) of the targets comprises cobalt oxide (CoO) and is substantially free from metallic chromium and a chromium alloy, and the other (second target) of the targets includes chromium. CoO in the first target is decomposed to be separated into Co and O, and the second target supplies chromium, and therefore, the formation of minute CoCr crystal grains and oxides having enhanced grain boundary widths can be achieved stably in a controlled manner, and with enhanced efficiency.

The chromium contained in the second target is not particularly limited, and may be any of metallic chromium, a Cr alloy and a chromium oxide.

A preferable example of the target is a combination of a first target which is a cobalt-platinum alloy substantially free from chromium, and further comprises cobalt oxide, with a second target comprising a cobalt- and chromium-containing alloy, and further comprising an oxide other than cobalt oxide. By using this combination of targets, a magnetic layer having a granular structure comprising CoCrPt magnetic grains can be obtained. The CoCrPt magnetic alloys are popularly used as a magnetic material. The oxide other than cobalt oxide is preferably at least one oxide selected from the group consisting of SiO₂, TiO, TiO₂, ZrO₂, Cr₂O₃, Ta₂O₅, Nb₂O₅ and Al₂O₃.

It is preferable that the first target comprised of a cobalt-platinum alloy substantially free from chromium, and a cobalt oxide, further comprises an oxide other than cobalt oxide. The oxide other than cobalt oxide is preferably at least one oxide selected from the group consisting of SiO₂, TiO, TiO₂, ZrO₂, Cr₂O₃, Ta₂O₅, Nb₂O₅ and Al₂O₃.

As specific examples of the combination of the first target and the second target, there can be mentioned combination of CoPt—CoO with CoCr—SiO₂; combination of CoPt—CoO with CoCr—TiO; combination of CoPt—CoO with CoCr—TiO—SiO₂; combination of CoPt—CoO with CoCr—TiO—SiO₂—TiO₂; combination of CoPt—SiO₂—CoO with CoCrPt—SiO₂; and combination of CoPt—SiO₂—CoO with CoCrPt—SiO₂—TiO.

The sputtering of at least two targets having different compositions can be conducted either by a co-sputtering step wherein the targets having different compositions are concurrently sputtered, or a sequential sputtering step wherein the targets having different compositions are sequentially sputtered. As one example, in the case when co-sputtering using a combination of a CoPt—CoO target with a CoCr—SiO₂ target is conducted, a single magnetic layer having a granular structure comprised of CoCrPt—SiO₂ or CoCrPt—SiO₂—CoO is formed. In the case when sequential sputtering using a combination of the same targets is conducted, a double magnetic layer having a granular structure comprised of a CoPt—CoO layer and a CoCr—SiO₂ layer. However, in the double magnetic layer, mutual dispersion of the elements of the CoPt—CoO layer and the CoCr—SiO₂ layer occur at the boundary thereof, and thus, it is deemed that a granular magnetic layer comprised of CoCrPt—SiO₂—CoO is formed at the boundary thereof. The sequential sputtering step is advantageous in that the sputtering can be effected by using two film-forming apparatuses each having one kind of target material. Thus, the total film-forming apparatus can be simple.

The perpendicular magnetic layer in the magnetic recording medium of the present invention is described with reference to FIG. 1.

A perpendicular magnetic layer 4 is formed on, for example, a second orientation control layer 3b. The perpendicular magnetic layer 4 comprises, for example, a first magnetic layer 4a, a second magnetic layer 7a, a third magnetic layer 4b, a forth magnetic layer 7b and a fifth magnetic layer 4c, which are formed in this order on the second orientation control layer 3b. It is preferable that the first magnetic layer 4a, the second magnetic layer 7a, the third magnetic layer 4b and the fourth magnetic layer 7b form together a multi-layer structure having a first magnetic layer comprising cobalt oxide and being substantially free from metallic chromium and a chromium alloy, and a second magnetic layer substantially free from cobalt oxide and containing chromium. For example, the first-fourth magnetic layers form together a multi-layer structure comprising a first magnetic layer 4a of CoPt—SiO₂—CoO, a second magnetic layer 7a of CoCrPt—SiO₂, a third magnetic layer 4b of CoPt—SiO₂—CoO, and a fourth magnetic layer 7b of CoCrPt—SiO₂. In this example of the multi-layer structure, a magnetic layer of CoCrPt—SiO₂—CoO is formed by the mutual dispersion of elements at the boundary between the adjacent two layers, as mentioned above. The magnetic layer of CoCrPt—SiO₂—CoO comprises minute magnetic CoCrPt grains and a non-magnetic oxide having a function of widening the grain boundary widths of the minute magnetic grains. A preferable constitution of the fifth magnetic layer 4c will be hereinafter described.

The crystal grains constituting the magnetic layers 4a, 4b, 7a and 7b are epitaxially grown to form columnar crystals S3 continuously extending from columnar crystals (S1+S2) in the first orientation control layer 3a and the second orientation control layer 3b (FIG. 2).

FIG. 3 is an enlarged vertical section of a multi-layer structure comprising magnetic layers constituting a perpendicular magnetic layer. A magnetic layer 4a constituting the perpendicular magnetic layer 4 has a granular structure comprising magnetic grains 41 preferably containing Co, Cr and Pt, and an oxide 42.

Preferable examples of the oxide 41 includes oxides of Si, Ta, Al, Ti, Mg and Co. Of these, TiO₂ and SiO₂ are especially preferable. The magnetic layer 4a is preferably comprised of a composite oxide made from two or more kinds of oxides. A most preferable composite oxide is TiO₂—SiO₂.

The magnetic grains 42 are preferably dispersed in the magnetic layer 4a, and preferably form a columnar structure upwardly extending through the magnetic layers 4a, 4b, 7a, 7b, and 4c. This columnar structure enhances the orientation property and crystalline property of the magnetic layer 4a, and gives a high signal/noise (S/N) ratio suitable for a high density recording.

To form a perpendicular magnetic layer 4 comprising crystal grains 42 having a columnar structure, the content of the oxide 41 in the magnetic layer 4a and the conditions for forming the magnetic layer 4a are important. The content of the oxide 41 in the magnetic layer 4a is preferably at least 3 mol % and not larger than 18 mol %, and more preferably at least 6 mol % and not larger than 13 mol %, as expressed as regarding the alloy comprising Co, Pt and others as one compound.

In the case when the content of the oxide 41 in the magnetic layer 4a is within the above range, an oxide 41 is deposited on the periphery of each magnetic grain 42 upon the formation of the magnetic layer 4a, whereby the magnetic grains 42 become more discrete and more minute. When the content of the oxide 41 is larger than the above range, the oxide 41 remains partly in the magnetic grains 42 and gives a baneful influence on the orientation property and crystalline property of the magnetic grains 42. Further, the oxide 41 is undesirably deposited above and under the magnetic grains 42, and consequently columnar structures of magnetic grains extending upwardly through the magnetic layers 4a to 4c are difficult to form. In contrast, when the content of the oxide 41 is smaller than the above range, the magnetic grains 42 cannot be rendered sufficiently discrete and minute, with the result that noise increases upon recordation and reproduction. The resulting signal/noise (S/N) ratio is too small to achieve a high-density recording.

The content of Pt in the magnetic layer 4a is preferably in the range of from 8 atomic % to 25 atomic %. When the content of Pt is too small, it is difficult to obtain a magnetic anisotropy index Ku desired for a perpendicular magnetic layer 4 exhibiting heat fluctuation characteristics suitable for a high-density recording. In contrast, when the content of Pt is too large, stacking faults occur inside the magnetic grains 42 leading to the reduction of the magnetic anisotropy index Ku. Further, when the content of Pt is too large, a layer of a FCC structure is undesirably formed within the magnetic grains 42, whereby the crystalline property and the orientation property are deteriorated. Thus the content of Pt in the magnetic layer 4a should preferably be within the above range for achieving the heat fluctuation characteristics and the recording/reproducing characteristics, which are desired for a high-density recording.

The magnetic grains 42 in the magnetic layer 42a may contain at least one element selected from the group consisting of B, Ta, Mo, Cu, Nd, W, Nb, Sm, Tb, Ru and Re, in addition to Co and Pt. By the incorporation of an element selected from these elements, the magnetic grains 42 can be rendered more minute and the crystalline property and the orientation property can be enhanced, and the heat fluctuation characteristics and the recording/reproducing characteristics, which are desired for a high-density recording, can be obtained.

The total content of the above-mentioned elements other than Co and Pt in the magnetic grains 42 is preferably not larger than 10 atomic %. When the total content of the above-mentioned elements is larger than 10 atomic %, phases other than the hcp phase are formed in the magnetic grains 42 with the result of disturbance in the crystalline property and the orientation property. Thus it is often difficult to obtain the heat fluctuation characteristics and the recording/reproducing characteristics, which are desired for a high-density recording.

As specific examples of the target material suitable for forming the magnetic layer 4a, there can be mentioned targets having the compositions: 80 (Co18Pt)-10 (SiO₂)-10 (CoO) (that is, a target comprised of 80 mole % of magnetic grain comprising 18 atomic % of Pt and the remainder of Co (as expressed as the magnetic grain being one compound), 10 mole % of SiO₂, and 10 mole % of CoO); 82 (Co16Pt)-8 (SiO₂)-10 (CoO); 84 (Co14Pt4Nb)-6 (Cr₂O₃)-10 (CoO); (CoPt)—(Ta₂O₅)—(CoO); (CoPt)—(Cr₂O₃)—(TiO₂)—(CoO); (CoPt)—(Cr₂O₃)—(SiO₂)—(CoO); (CoPt)—(Cr₂O₃)—(SiO₂)—(TiO₂)—(CoO); (CoPtMo)—(TiO)—(CoO); (CoPtW)—(TiO₂)—(CoO); (CoPtB)—(Al₂O₃)—(CoO); (CoPtTaNd)—(MgO)—(CoO); (CoPtBCu)—(Y₂O₃)—(CoO); and (CoPtRu)—(SiO₂)—(CoO).

As illustrated in FIG. 3, the magnetic layer 4b constituting the perpendicular magnetic layer 4 is a magnetic layer having a granular structure, which is similar to the above-mentioned magnetic layer 4a. A preferable composition of the magnetic layer 4b and a target material for forming the magnetic layer 4b are similar to those of the above-mentioned magnetic layer 4a.

In FIG. 3, the magnetic layers 7a and 7b constituting the perpendicular magnetic layer 4 are magnetic layers having a granular structure, which are similar to the above-mentioned magnetic layers 4a and 4b. These magnetic layers 7a and 7b preferably comprise magnetic grains 42 containing Co, Cr and Pt, and an oxide 41. A target used for forming the magnetic layers 7a and 7b comprises an alloy containing Co, Cr and Pt, and an oxide. This target comprises a Cr alloy and therefore, even if CoO is incorporated as an oxide in the target, the CoO is difficult to be present as it is within the target, as described above.

The oxide 41 in the magnetic layers 7a and 7b is preferably at least one oxide selected from the group consisting of oxides of Cr, Si, Ta, Al, Ti, Mg and Co. Of these, TiO₂, Cr₂O₃ and SiO₂ are preferably used as the oxide 41. Another preferable example of the oxide 41 in the magnetic layers 7a and 7b is a composite oxide comprised of two or more oxides. Specific examples of the composite oxide are Cr₂O₃—SiO₂, Cr₂O₃—TiO₂, and Cr₂O₃—SiO₂—TiO₂.

The magnetic grains 42 constituting the magnetic layers 7a and 7b are preferably dispersed in the magnetic layers 7a and 7b.

The magnetic grains 42 preferably form a columnar structure upwardly extending through the magnetic layers 4a, 7a, 4b, 7b and 4c, whereby the crystalline property and orientation property of the magnetic grains 42 in the magnetic layers 7a and 7b are improved and consequently a large signal/noise (S/N) ratio suitable for high-density recording is obtained.

The content of the oxide 41 in the magnetic layers 7a and 7b is preferably in the range of from 3 mole % to 18 mole %, more preferably from 6 mole % to 13 mole %, based on the total of compounds containing Co, Cr and Pt. The reason for which this range of content is preferable is the same as that for which the above-mentioned range of content of the oxide 41 in the magnetic layers 4a and 4b constituting the perpendicular magnetic layer 4.

The content of Cr in the magnetic layers 7a and 7b is preferably in the range of from 4 atomic % to 18 atomic %, more preferably from 8 atomic % to 15 atomic %. When the content of Cr is within this range, the magnetic anisotropy index Ku of the magnetic grains 42 is not lowered to undesirable extent and a high magnetization is maintained, and consequently, the recording/reproducing characteristics and the heat fluctuation characteristics, which are desired for a high-density recording are obtained.

When the content of Cr in the magnetic layers 7a and 7b is larger than the above range, the magnetic anisotropy index Ku of the magnetic grains 42 decreases to undesirable extent and the heat fluctuation characteristics are deteriorated, and the crystalline property and the orientation property of the magnetic grains 42 are deteriorated. Consequently, the recording/reproducing characteristics are deteriorated. In contrast, when the content of Cr is smaller than the above range, the magnetic anisotropy index Ku of the magnetic grains 42 increases and the perpendicular coercivity becomes too high and it is difficult to write sufficiently for recording by a magnetic head. Consequently, the recording (OW) characteristics are not suitable for high-density recording.

The content of Pt in the magnetic layers 7a and 7b is preferably in the range of from 10 atomic % to 25 atomic %. When the content of Pt is smaller than this range, the magnetic anisotropy index Ku required for the perpendicular magnetic layer 4 is not obtained, and the heat fluctuation characteristics are not suitable for high-density recording. In contrast, when the content of Pt is larger than this range, stacking faults occur inside the magnetic grains 42 and consequently the magnetic anisotropy index Ku decreases to undesirable extent. Further, when the content of Pt is too large, a layer having a fcc structure is formed in the magnetic grains 42, and the crystalline property and the orientation property tend to be poor. Thus, the content of Pt in the magnetic layers 7a and 7b should preferably be within the above range to obtain the heat fluctuation characteristics and the recording/reproducing characteristics, suitable for high-density recording.

The magnetic grains 42 in the magnetic layers 7a and 7b may contain at least one element selected from the group consisting of B, Ta, Mo, Cu, Nd, W, Nb, Sm, Tb, Ru and Re, in addition to Co, Cr and Pt. By the incorporation of an element selected from these elements, the magnetic grains 42 can be rendered more minute and the crystalline property and the orientation property can be enhanced, and the heat fluctuation characteristics desired for a high-density recording can be obtained.

The total content of the above-mentioned elements other than Co, Cr and Pt in the magnetic grains 42 in the magnetic layers 7a and 7b is preferably not larger than 10 atomic %. When the total content of the above-mentioned elements is too large, phases other than the hcp phase are formed in the magnetic grains 42 with the result of disturbance in the crystalline property and the orientation property. Thus it is often difficult to obtain the heat fluctuation characteristics and the recording/reproducing characteristics, desired for a high-density recording.

The magnetic layer 4c constituting the perpendicular magnetic layer 4 preferably comprises magnetic grains 42 containing Co and Cr, and is substantially free from an oxide 41, as illustrated in FIG. 3. The magnetic grains 42 in the magnetic layer 4c are preferably epitaxially grown to form columnar crystals on the magnetic grains 42 in the magnetic layer 4a. Magnetic grains 42 in the magnetic layers 4a-4c are preferably epitaxially grown in a manner such that a magnetic grain in each magnetic layer forms an upwardly extending columnar crystal together with a magnetic grain in the adjacent magnetic layer. That is, a magnetic grain 42 in the magnetic layer 4b is epitaxially grown from a magnetic grain 42 in the magnetic layer 4a, whereby the magnetic grains 42 are rendered minute and the crystalline property and the orientation property are improved.

The content of Cr in the magnetic layer 4c is preferably in the range of from 10 atomic % to 24 atomic %. When the content of Cr is within this range, a sufficient output can be obtained at reproduction of data and the desired heat fluctuation characteristics can be obtained. When the content of Cr is too large, the magnetization of the magnetic layer 4c becomes too small. In contrast, when the content of Cr is too small, the magnetic grains 42 are rendered minute and discrete to an insufficient extent and the noise at recordation/reproduction increases, and thus a large signal/noise (S/N) ratio suitable for high-density recording cannot be obtained.

In the case when the magnetic grains 42 constituting the magnetic layer 4c contains Pt in addition to Co and Cr, the content of Pt in the magnetic layer 4c is preferably in the range of from 8 atomic % to 25 atomic %. When the content of Pt is within this range, a coercivity sufficient for high-density recording can be obtained, and a high reproduction output can be maintained at recordation/reproduction. Consequently the recording/reproducing characteristics and the heat fluctuation characteristics, which are suitable for high-density recording, are obtained. When the content of Pt in the magnetic layer 4c is too large, a fcc phase tends to be formed in the magnetic layer 4c, and the crystalline property and the orientation property are often deteriorated. In contrast, when the content of Pt is too small, a magnetic anisotropy index Ku suitable for giving heat fluctuation characteristics for the desired high-density recording cannot be obtained.

The magnetic grains 42 constituting the magnetic layer 4c form a magnetic layer having a non-granular structure, and can contain at least one element selected from the group consisting of B, Ta, Mo, Cu, Nd, W, Nb, Sm, Tb, Ru, Re and Mn, in addition to Co, Cr and Pt. By the incorporation of an element selected from these elements, the magnetic grains 42 can be rendered more minute and the crystalline property and the orientation property can be enhanced, and the heat fluctuation characteristics and recording/reproducing characteristics, desired for a higher-density recording, can be obtained.

The total content of the above-mentioned elements other than Co, Cr and Pt in the magnetic grains 42 in the magnetic layers 4c is preferably not larger than 16 atomic %. When the total content of the above-mentioned elements is too large, phases other than the hcp phase are formed in the magnetic grains 42 with the result of disturbance in the crystalline property and the orientation property. Thus it is often difficult to obtain the heat fluctuation characteristics and the recording/reproducing characteristics, desired for a high-density recording.

The material suitable for the magnetic layer 4c includes, for example, CoCrPt and CoCrPtB. The CoCrPtB is preferably such that the total content of Cr plus B is in the range of from 18 atomic % to 28 atomic %.

A preferable example of the CoCrPt is Co14-24Cr8-22Pt (that is, a material containing 14-24 atomic % of Cr, 8-22 atomic % of Pt and the remainder of Co). A preferable example of the CoCrPtB is Co10-24Cr8-22Pt0-16B (that is, a material containing 10-24 atomic % of Cr, 8-22 atomic % of Pt, 0-16 atomic % of B and the remainder of Co).

The material for the magnetic layer 4c further includes, for example, CoCrPtTa such as Co10-24Cr8-22Pt1-5Ta (that is, a material containing 10-24 atomic % of Cr, 8-22 atomic % of Pt, 1-5 atomic % of Ta and the remainder of Co); CoCrPtTaB such as Co10-24Cr8-22Pt1-5Ta1-10B (that is, a material containing 10-24 atomic % of Cr, 8-22 atomic % of Pt, 1-5 atomic % of Ta, 1-10 atomic % of B and the remainder of Co); CoCrPtBNd; CoCrPtTaNd; CoCrPtNb; CoCrPtBW; CoCrPtMo; CoCrPtCuRu; and CoCrPtRe.

The perpendicular magnetic layer 4 preferably has a perpendicular coercivity (Hc) of at least 3,000 Oe. When the coercivity is smaller than 3,000 Oe, the recording/reproducing characteristics, especially frequency characteristics, and the heat fluctuation characteristics are deteriorated, and thus the magnetic recording medium is not suitable for high-density recording, The perpendicular magnetic layer 4 preferably has a reverse magnetic domain nucleation magnetic field (−Hn) of at least 1,500 Oe. When the reverse magnetic domain nucleation magnetic field (−Hn) is smaller than 1,500 Oe, the heat fluctuation characteristics are not satisfactory.

The magnetic grains 42 in the perpendicular magnetic layer 4 preferably has an average grain diameter in the range of 3 to 12 nm and a grain boundary width in the range of 0.5 to 4 nm. In a preferred embodiment of the present invention, the average grain diameter can be smaller than 6 nm, the grain boundary width of a Co magnetic grains can be at least 1.5 nm, and the boundary face of the magnetic grains can be sharp and clear. The average grain diameter of magnetic grains, the grain boundary width, and the sharpness of the boundary face of magnetic grains can be determined by observation of the perpendicular magnetic layer 4 by transmission electron micrograph (TEM), and the image processing.

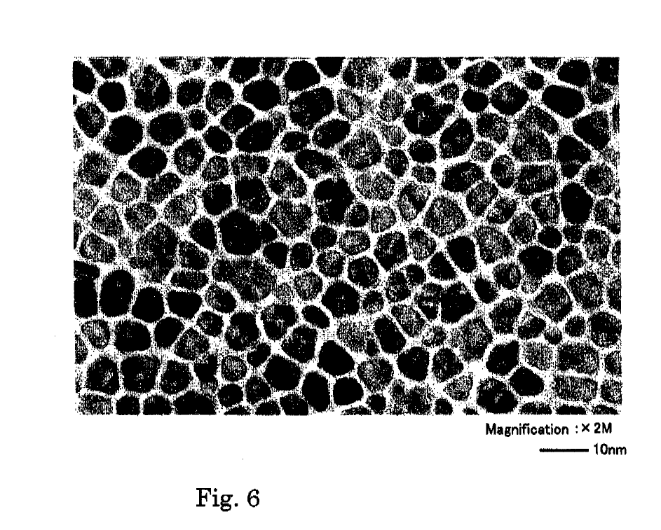

FIG. 5 is a TEM photograph of the granular magnetic layer of the magnetic recording medium according to the present invention; and FIG. 6 is a TEM photograph of the granular magnetic layer of a magnetic recording medium according to prior art.

The magnetic grains constituting the granular magnetic layer according to the present invention have an average grain diameter of not larger than 6 nm, a grain boundary width of at least 1.5 nm. The boundary face of the magnetic grains is sharp and clear, and the magnetic grains are sufficiently discrete. The average grain diameter of the magnetic grains as determined by image processing of TEM photograph shown in FIG. 5 is 5.9 nm, and the grain boundary width as similarly determined is 1.5 nm. In contrast, the average grain diameter of the magnetic grains shown in FIG. 6 is 6.7 nm and the grain boundary width thereof is 0.9 nm.

The perpendicular magnetic layer 4 preferably has a thickness in the range of from 5 to 20 nm. When the thickness of the perpendicular magnetic layer is too small, the reproduction output is in sufficient and the heat fluctuation characteristics are deteriorated. In contrast, when the thickness of the perpendicular magnetic layer is too large, the magnetic grains 42 in the perpendicular magnetic layer are bloated and noise at recordation/reproduction increases. Consequently recording/reproducing characteristics represented by the signal/noise (S/N) ratio and the recording (OW) characteristics are deteriorated.

In the magnetic recording medium of the present invention, it is preferable that magnetic layers 4a to 7b on the side of non-magnetic substrate 1 among the magnetic layers 4a, 7a, 4b, 7b and 4c, have a granular structure; and the magnetic layer 4c on the side of the protective overcoat 5 has a non-granular structure which is substantially free from an oxide. By this constitution, the heat fluctuation characteristics, the recording (OW) characteristics, and the signal/noise (S/N) ratio of the magnetic recording medium can be controlled or adjusted with ease.

In the present invention, the perpendicular magnetic layer 4 can be comprised of at least six layers. For example, in addition to the above-mentioned four magnetic layers 4a to 7b, a magnetic layer having a granular structure is formed, and further a magnetic layer containing an oxide is formed thereon.

Further in the present invention, a non-magnetic layer can be inserted among plural magnetic layers constituting the magnetic layer 4. As described above, mutual dispersion preferably occurs between the magnetic layers 4a and 4b, and the magnetic layers 4b and 7b. When a non-magnetic layer is inserted among plural magnetic layers, the insertion of the non-magnetic layer should preferably be effected in a manner and under conditions such that the mutual dispersion is not hindered. For example, in one embodiment, a non-magnetic layer is inserted between the magnetic layer 4b and the magnetic layer 7b, but not inserted between the magnetic layer 4a and the magnetic layer 7a. In another embodiment, a non-magnetic layer is inserted only between the magnetic layer 7b and the magnetic layer 4c. In still another embodiment, a non-magnetic layer is inserted between the magnetic layer 4b and the magnetic layer 7b, and further a non-magnetic layer is inserted between the magnetic layer 7b and the magnetic layer 4c.

The non-magnetic layer is preferably formed from a material having a hcp structure. As specific examples of such material, there can be mentioned Ru, a Ru alloy, a CoCr alloy and a CoCrX₁ alloy wherein X₁ is at least one element selected from the group consisting of Pt, Ta, Zr, Re, Ru, Cu, Nb, Ni, Mn, Ge, Si, O, N, W, Mo, Ti, V, Zr and B.

The non-magnetic layer can also be formed from a material having another structure, provided that the non-magnetic layer does not influence the crystalline property and orientation property of the adjacent magnetic layers. As specific examples of such material, there can be mentioned Pd, Pt, Cu, Ag, Au, Ir, Mo, W, Ta, Nb, V, Bi, Sn, Si, Al, C, B and Cr, and alloys of these metals. Preferable Cr alloys are those which are expressed by the formula CrX₂ wherein X₂ is at least one element selected from the group consisting of Ti, W, Mo, Nb, Ta, Si, Al, B, C and Zr. The Cr alloys preferably contain Cr in an amount of at least 60 atomic %.

The non-magnetic layer preferably has a structure such that the metal particles of the above-mentioned alloys are dispersed in an oxide, a metal nitride or a metal carbide, and more preferably has a structure such that metal particles form a columnar structure penetrating the non-magnetic layer. As specific examples of the disperse medium, there can be mentioned oxides such as SiO₂, Al₂O₃, Ta₂O₅, Cr₂O₃, MgO, Y₂O₃ and TiO₂; metal nitrides such as AlN, Si₃N₄, TaN and CrN; and metal carbides such as TaC, BC and SiC. The non-magnetic layer can also be formed from CoCr—SiO₂, CoCr—TiO₂, COCr—Cr₂O₃, CoCrPt—Ta₂O₅, Ru—SiO₂, Ru—Si₃N₄ and Pd—TaC.

Protective Overcoat

A protective overcoat 5 is formed on the perpendicular magnetic layer 4. The protective overcoat 5 has a function of preventing corrosion of the perpendicular magnetic layer 4, and preventing damage occurring upon contact of a magnetic head with the magnetic recording medium. The protective overcoat 5 can be made from a conventional material such as, for example, those containing C, SiO₂ or ZrO₂. The protective overcoat 5 preferably has a thickness of from 1 nm to 10 nm which ensures a small distance between a magnetic head and the magnetic recording medium and therefore is suitable for high-density recording. The protective overcoat can be formed by, for example, chemical vapor deposition (CVD).

Lubricating Layer

A lubricating layer 6 is formed on the protective overcoat 5. The lubricating layer 6 formed from a lubricating material such as, for example, perfluoropolyether, fluorinated alcohol or fluorinated carboxylic acid. The lubricating layer can be formed by, for example, a dipping method.

Magnetic Recording/Reproducing Apparatus

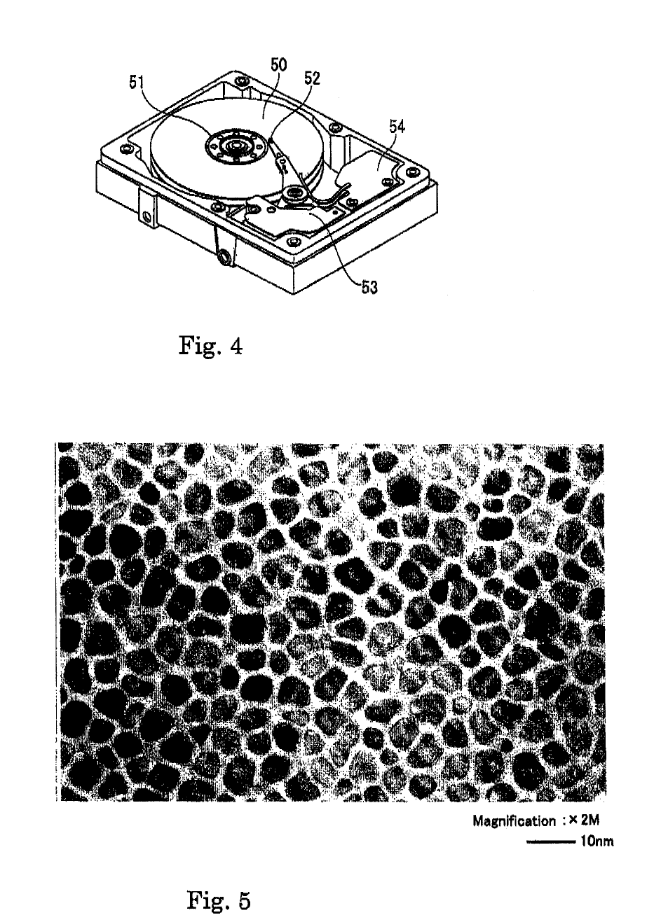

In FIG. 4 illustrating an example of the magnetic recording/reproducing apparatus according the present invention, the magnetic recording/reproducing apparatus comprises, in combination, a magnetic recording medium 50 having a constitution as illustrated in FIG. 1; a driving part 51 for driving the magnetic recording medium 50 in the circumferential recording direction; a magnetic head 52 for recording an information in the magnetic recording medium 50 and reproducing the information from the medium 50; a head-driving part 53 for moving the magnetic head 52 in a relative motion to the magnetic recording medium 50; and a recording-and-reproducing signal treating means 54.

The recording-and-reproducing signal treating means 54 has a function of transmitting signal from the outside to the magnetic head 52, and transmitting the reproduced output signal from the magnetic head 52 to the outside.

As the magnetic head 52 provided in the magnetic recording/reproducing apparatus, there can be used a magnetic head provided with a reproduction element suitable for high-magnetic recording density, which includes, for example, a GMR element exhibiting a giant magneto-resistance (GMR) effect.

Since the magnetic recording/reproducing apparatus illustrated in FIG. 4 is provided with the magnetic recording medium 50 according to the present invention as illustrated in FIG. 1, and a magnetic head 52 for recording an information in the medium 50 and reproducing the information from the medium 50, it exhibits a high signal/noise (S/N) ratio suitable for high recording density, and excellent recording (OW) characteristics.

### EXAMPLES

The invention will now be specifically described by the following examples that should be construed not to limit the scope of the invention. The invention can be practiced on modified embodiments within the scope of the invention.

Production of Target Containing CoO

A target having the composition: 82-[Co16Pt]-10(CoO)-5(SiO₂)-3(Cr₂O₃) was produced by the following procedures.

Powders of Co16Pt, CoO, SiO₂ and Cr₂O₃ were prepared by a gas atomizing method. The powders had an average particle diameter of approximately 5 μm. The powders were mixed together at a predetermined ratio. The mixture was placed in a mold for pre-molding. The pre-molded mixture was subjected to hot-pressing at a temperature of 800° C. and a pressure of 200 kgf/cm² in an argon atmosphere to be thereby sintered. The sintered body was cut into a desired target shape to give a target having the above-mentioned composition.

A target having the composition: 82-[Co16Pt]-10(CoO)-5(SiO₂)-3(TiO₂) was also produced by substantially the same procedures as mentioned above.

### Example 1

A magnetic recording medium was produced by the following method, and its characteristics were evaluated.

A cleaned glass substrate having an outer diameter of 2.5 inches (available from Konica Minolta Holdings Inc.) was placed in a film-forming chamber of an DC magnetron sputtering apparatus (“C-3040” available from Anelva Co.) and the chamber was evacuated to a reduced pressure of 1×10⁻⁵ Pa. Then, a Cr adhesion layer having a thickness of 10 nm was formed on the glass substrate by using a Cr target.

Then a soft magnetic layer with a thickness of 25 nm was formed on the adhesion layer at a substrate temperature below 100° C. by sputtering a target having the composition: Co-20Fe-5Zr-5Ta (that is, a target comprised of 20 atomic % of Fe, 5 atomic % of Zr, 5 atomic % of Ta, and the remainder of Co). A Ru layer with a thickness of 0.7 nm was formed on the soft magnetic layer, and then a soft magnetic layer with a thickness of 25 nm having the composition: Co-20Fe-5Zr-5Ta was formed on the Ru layer. Thus, a soft magnetic underlayer comprised of three layers, i.e., a soft magnetic layer, a Ru layer and a soft magnetic layer, was formed.

Thereafter, an orientation control layer was formed on the soft magnetic underlayer by a sputtering method. The orientation control layer was comprised of a first orientation control layer comprised of Ru and formed on the soft magnetic underlayer, and a second orientation control layer comprised of Ru and formed on the first orientation control layer. The sputtering for forming the first orientation control layer was conducted at a gas pressure of 3 Pa, and the sputtering for forming the second orientation control layer was conducted at a gas pressure of 10 Pa.

Thereafter, a perpendicular magnetic layer was formed on the second orientation control layer as follows.

A first magnetic layer with a thickness of 4 nm was formed on the second orientation control layer at a sputtering gas pressure of 2 Pa by sputtering a target having the composition: 82 (Co16Pt)-10 (CoO)-5 (SiO₂)-3 (TiO₂) (that is, a target comprised of 82 mol % of an alloy consisting of 16 atomic % of Pt and the remainder of Co, 10 mol % of an oxide comprised of CoO, 5 mol % of an oxide comprised of SiO₂, and 3 mol % of an oxide comprised of TiO₂).

Then a second magnetic layer with a thickness of 4 nm was formed on the first magnetic layer at a sputtering gas pressure of 2 Pa by sputtering a target having the composition: 92 (Co11Cr18Pt)-5 (SiO₂)-3 (TiO₂).

Further, a third magnetic layer with a thickness of 4 nm was formed on the second magnetic layer at a sputtering gas pressure of 2 Pa by sputtering a target having the composition: 82(Co16Pt)-10(CoO)-5(SiO₂)-3(Cr₂O₃).

Further, a fourth magnetic layer with a thickness of 4 nm was formed on the third magnetic layer at a sputtering gas pressure of 2 Pa by sputtering a target having the composition: 92(Co11Cr18Pt)-5(SiO₂)-3(Cr₂O₃).

A non-magnetic layer comprised of Ru with a thickness of 0.3 nm was formed on the fourth magnetic layer, and further a magnetic layer with a thickness of 7 nm was formed on the non-magnetic layer at a sputtering gas pressure of 0.6 Pa by sputtering a target having the composition: Co20Cr14Pt3B (that is, a target comprised of 20 atomic % of Cr, 14 atomic % of Pt, 3 atomic % of B and the remainder of Co).

Thereafter a protective overcoat with a thickness of 3.0 nm was formed on the above-mentioned magnetic layer by a CVD method. Finally a lubricating layer comprised of perfluoropolyether was formed on the protective overcoat, to give a magnetic recording medium.

Recording/reproducing characteristics of the magnetic recording medium were evaluated by measuring a signal/noise ratio (S/N ratio) and recording characteristics (OW) thereof were evaluated. For these evaluations, a read write analyzer “RWA 1632” and a spinstand “S1701MP”, which are available from GUZIK Technical Enterprises, US, were used. A magnetic head used was provided with a single magnetic pole on the write side and TMR junctions on the readout side.

The signal/noise ratio (S/N ratio) was measured as a recording density of 750 kFCl.

The recording characteristics (OW) were evaluated as follows. First, a signal of 750 kFCl was written and then a signal of 100 kFCl was overwritten. A high frequency component is taken out by a frequency filter, and the capacity of writing data was evaluated by the residual ratio. The S/N ratio was 13.90 dB, and the OW was 42.0 dB.

After the evaluation of S/N ratio and OW, the granular structure of the magnetic layer was observed by TEM, and thus it was revealed that the magnetic grains had an average grain diameter of 5.8 nm, the grain boundary width was 1.6 nm, and the boundaries of magnetic grains were clear and sharp.

### Comparative Example 1

For comparison purpose, a magnetic recording medium was produced by the same method as mentioned in Example 1, except that magnetic layers were formed by the following procedures with all other conditions and procedures remaining the same.

A first magnetic layer with a thickness of 8 nm was formed on the second orientation control layer at a sputtering gas pressure of 2 Pa by sputtering a target having the composition: 92(Co11Cr18Pt)-5(SiO₂)-3(TiO₂).

Then a second magnetic layer with a thickness of 8 nm was formed on the first magnetic layer at a sputtering gas pressure of 2 Pa by sputtering a target having the composition: 92(Co11Cr18Pt)-5(SiO₂)-3(Cr₂O₃).

A non-magnetic layer comprised of Ru with a thickness of 0.3 nm was formed on the second magnetic layer.

A further magnetic layer with a thickness of 7 nm was formed on the non-magnetic layer at a sputtering gas pressure of 0.6 Pa by sputtering a target having the composition: Co20Cr14Pt3B (that is, a target comprised of 20 atomic % of Cr, 14 atomic % of Pt, 3 atomic % of B and the remainder of Co).

Recording/reproducing characteristics of the magnetic recording medium were evaluated by the same methods as mentioned in Example 1. The S/N ratio was 13.90 dB, and the OW was 42.0 dB.

After the evaluation of S/N ratio and OW, the granular structure of the magnetic layer was observed by TEM, and thus it was revealed that the magnetic grains had an average grain diameter of 6.7 nm, the grain boundary width was 0.8 nm, and the boundaries of magnetic grains were poor in clearness and sharpness as compared with those observed in Example 1.

1. A magnetic recording medium which has been made by forming at least one magnetic layer having a granular structure on a substrate by sputtering, characterized in that said at least one magnetic recording layer having a granular structure comprises magnetic grains which are separated from each other by an oxide, and said at least one magnetic recording layer having a granular structure is made by sputtering a target which comprises cobalt oxide and is substantially free from metallic chromium and a chromium alloy.

2. The magnetic recording medium according to claim 1, wherein said at least one magnetic recording layer having a granular structure comprises magnetic grains having an average grain diameter of not larger than 6 nm; and said magnetic grains are separated from each other by the oxide with a grain boundary width of at least 1.5 nm.

3. The magnetic recording medium according to claim 1, wherein said at least one magnetic recording layer having a granular structure has been formed by a co-sputtering step wherein at least two targets having different compositions are concurrently sputtered, or a sequential sputtering step wherein at least two targets having different compositions are sequentially sputtered; and,
at least one of said at least two targets, used in the co-sputtering step and the sequential sputtering step, includes a first target comprising cobalt oxide and being substantially free from metallic chromium and a chromium alloy, and the other of said at least two targets includes a second target containing chromium.

4. The magnetic recording medium according to claim 3, wherein the first target comprises a cobalt-platinum alloy which is substantially free from chromium, and further comprises cobalt oxide; and the second target comprises a cobalt- and chromium-containing alloy, and further comprises an oxide other than cobalt oxide.

5. The magnetic recording medium according to claim 4, wherein the oxide other than cobalt oxide, contained in the second target, is at least one oxide selected from the group consisting of SiO₂, TiO, TiO₂, ZrO₂, Cr₂O₃, Ta₂O₅, Nb₂O₅ and Al₂O₃.

6. The magnetic recording medium according to claim 4, wherein the first target comprises a cobalt-platinum alloy which is substantially free from chromium, and further comprises cobalt oxide, and an oxide other than cobalt oxide.

7. The magnetic recording medium according to claim 6, wherein the oxide other than cobalt oxide, contained in the first target, is at least one oxide selected from the group consisting of SiO₂, TiO, TiO₂, ZrO₂, Cr₂O₃, Ta₂O₅, Nb₂O₅ and Al₂O₃.

8. A magnetic recording/reproducing apparatus characterized as being provided with a magnetic recording medium as claimed in claim 1, and a magnetic head for recording and reproducing an information in the magnetic recording medium.
